(19) United States
(12) Patent Application Publication
(10) Pub. No.: US 2004/0146608 A1
(43) Pub. Date: Jul. 29, 2004

(54) Coated food product with jalapeno pieces

(76) Inventor: Pablo Yzquierdo, Weiser, ID (US)

Correspondence Address: DYKAS, SHAVER & NIPPER, LLP, P.O. BOX 877, 802 WEST BANNOCK STREET, SUITE 405, BOISE, ID, 83701, US

(21) Appl. No.: 10/351,105

(22) Filed: Jan. 23, 2003

(51) Int. Cl. A23G 3/00

(52) U.S. Cl. 426/94

(57) ABSTRACT

A coated food product having a coating having jalapeno pepper pieces.

### BACKGROUND OF THE INVENTION

1. Field of the Invention.

The present invention generally relates to coated, processed food products, and more particularly to a coated food product that contains jalapeno peppers as a part of the food coating.

2. Background Information.

A variety of foods are prepared for consumption by coating them with a batter and then cooking the food product with the batter on them by a method such as frying. The batter or dip, which is on the food item, creates a desired coating upon the item to be cooked.

One example of such an item is a so-called onion ring, which is sold in a variety of locations, typically in forums such as sporting events, tractor pulls, and state fairs. Onion rings are also served as appetizers in a variety of locations.

An onion ring is basically made up of an onion which is washed, partially peeled and sliced to produce an O-shaped ring. These O-shaped rings are then placed within a batter and coated with the batter. The onion, which is now coated in batter, is then placed into a fryer that contains hot cooking oil and cooked for a period of time.

The invention is a food product with a batter coating that includes a spiced element that provides desired flavor quality to an individual consuming the food. Another purpose of the invention is to provide a method for making a food product, which has a coating that contains jalapeno peppers, which can be prepared at one location, stored for a period of time, reheated, and then served at another location. Another purpose of the invention is to provide a novel good tasting food product.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

The invention is a food product that has an outer coating containing jalapeno peppers that can be quickly prepared for consumption by an end user or by a retail merchant for sale to an end consumer. The present invention includes jalapenos that provide a desired element of flavor, spiciness, and heat to the food product, as well as imparting flavor qualities to the item being cooked.

With such an invention, it is anticipated that this invention could be prepared from fresh ingredients or could be prepared in a dry prepackaged and prepared mix, which could then be reconstituted by simply adding a liquid. This combination would provide a ready to use batter to cook a variety of products. While in the preferred embodiment the invention is described in the context of a coated onion ring, it is to be understood that the principles of the invention could be applied to any of a variety of items including, but not limited to other types of vegetables, tubers, fruits, meats, cheeses, breads, and other food stuffs.

The raw food product is prepared by being washed, peeled, cut, and dimensioned to achieve a desired size. In the preferred embodiment of the onion the onions are washed, peeled, and centered to achieve rings of the desired size and shape. After this is done, the now washed and dimensioned food product is dipped within a batter having jalapeno peppers together with a variety of other items. The other items in the batter typically include: a quantity of flour and an amount of liquid. In some applications, binding agents or other items may be added to the combination to provide the batter with the desired attributes and characteristics.

The flour used in the batter is typically wheat flour, although other flours such as corn flour may also be used, as well as various combinations of different grain flours may be used. In many inventions, the liquid used in the invention may be milk or a variety of other similar liquids, such as buttermilk, whole milk, skim milk, evaporated milk, condensed milk, etc. Milk based products provide sufficient protein content to the mixture and assist to adhere the coating mixture to the onion ring. Milk also contains a variety of other attributes in addition to protein, such as fat that provides the onion ring with certain browning qualities. Besides, enhancing taste and flavor, the fat in the milk provides structure, tenderness, color, flavor, and flavor release. Other liquids may also be used in varying proportions so as to effectuate the desired results. These liquids include, but are not limited to, water, lemon juice, beer, and other liquids.

The flour and the liquid are mixed together in desired quantities to arrive at a batter having a desired consistency. Generally, the consistency must be sufficient to adhere sufficient amounts of the batter to, in this case, the onion slice, which is being dipped within the batter. The batter must be sufficiently thick so as to adhere to the onion ring being placed within. Depending upon the desires of the person making the onion rings, the amount of flour and liquid may be modified so as to achieve a desired consistency and result. In some applications, onion rings having a greater thickness and crust may be desired, in other embodiments less of a crust or coating is desired. These results may be achieved in a variety of ways including altering the amount of coating which is placed upon the onion rings as well as modifying the consistency of the batter mix.

To this liquid and flour mixture a desired quantity of jalapeno pepper pieces is added. In the preferred embodiment, these pieces are diced. However, it is to be understood that the peppers may be cut in a variety of ways so as to both form a portion of the batter as well as to adhere to the item being placed within the batter prior to cooking. While jalapeno peppers are described in the preferred embodiment, as well as in this invention, it is to be understood that other generally equivalent types of peppers may also be used and are contemplated within the scope of this invention, including cayenne peppers, habanera peppers, and other peppers that provide the desired qualities of taste, flavor, and heat to the food product. Jalapenos are chosen because they are common in many types of foods, particularly Mexican foods, and Mexican foods are increasingly more popular within the United States.

A variety of other items may be added to the general mixture that is set forth to give the batter desired characteristics. The coating mixture may also have a binding agent within the coating mixture. The bindings can be selected from items such as eggs, shortening, and oil. These binding agents provide a variety of attributes to the batter mixture. The eggs provide protein to the mixture, and would enable the cooked batter to provide qualities of increased browning and hardening. Shortening and oil will also contribute to the tenderness, structure, color, flavor, and flavor release of the foods involved. The shortening and oil would also contribute to retaining moisture within the onion ring so as to provide a desired quality to the person eating the onion ring, namely that the onion ring would be crunchy on the outside and soft on the inside.

The coating mixture may also include a desired quantity of baking powder. Baking powder provides rising properties when used in cooking. It will provide for battered onion rings to be crunchier and flake from the top of the onion ring. Besides baking powder, a variety of other materials may also be included that provide a desired level of bubbling to the batter. These would include materials such as beer, soda pop or other liquids that have bubbles of gas stored within the liquid.

In addition, the coating mixture may have a desired quantity of salt. The salt provides a desired level of saltiness perceived by the person consuming the items. This salt also affects the taste of the onion ring. In addition, a sugar may be added either for taste or to enhance the rising qualities of the batter.

After the item has been coated with the batter, it is breaded with a breaded coating. This breaded coating is made up of wheat and barley flour mixture together with whey, buttermilk, corn syrup, and other ingredients that are cooked together until forming a crisp generally dry product. Jalapeno peppers can also be added to this mixture to produce coating having a desired amount of flavor and heat. This dry breading mixture is sprinkled upon the coated onion rings prior to the coated onion rings passing on for cooking.

After the food products have been washed, peeled, cut, coated, and breaded, the items are then passed on for cooking. The items may be cooked in a variety of ways, including frying in oil or by being baked in an oven. These items may be cooked for a period of time sufficient so as to allow the coating to cook as well as for the food product within the coating to be cooked. In other instances the items may be cooked for a shorter period of time so as to only allow the outer coating portion of the item to be cooked. This assists to adhere the outer coating to the food product and assists to hold the food products together.

Once the food product has been partially cooked, the items can be cooled and placed in an appropriate storage container and medium. One way that this is done is to place the cooled food items into a container covered in wax paper or other suitable container that will provide adequate storage capabilities for the items depending upon the necessities of the consumers. These storage boxes are then frozen to ensure that the food products are kept properly and are ready for subsequent use by a consumer.

When an end consumer such as an individual in their home or a retail food service establishment desired to prepare and serve or eat the items, the items can be removed from the container and heated for a desired period of time to heat the previously cooked product and to cook the other portions of the item.

This product provides a novel new tasting product that can be easily obtained and prepared for consumption by a variety of individuals in a variety of circumstances.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The present invention is a jalapeno coated food product that is easy to be prepared and served by consumers or retail food establishments. In the preferred embodiment, the food product is an onion ring covered in a batter that contains jalapeno peppers, sprinkled with a coating which contains jalapeno pieces, partially cooked, and frozen for later heating and consumption. While the present invention is described in the context of onion rings, it is to be distinctly understood that the invention may be variously employed upon a variety of other foods which may be coated, breaded, partially cooked, and then frozen for later heating and consumption.

In the preferred embodiment, the onions that will become the onion rings are prepared from one of the so-called “Sweet Spanish Varieties” of yellow onions having a diameter of no less then 3½ inches. In particular, those onions that are graded and sold by the members of the Spanish Idaho and Eastern Oregon Onion Association work best in this embodiment. These onions are washed, peeled, and sliced. The resulting slices of the onions are in thickness from ⅜″ to ½″, which generally produces rings that will meet customer specifications. From these slices, the center portion of the rings are removed resulting in onion pieces that have a generally circular ring shape. Depending upon the desires of the customers, the size and variety of the onions may be varied, as may the shape of the onion pieces themselves. The examples in this disclosure are simply a disclosure of the best mode known by the inventor to perform this invention.

Once the raw onion product is prepared, the onion slices are taken and dipped in a batter that is made of a combination of “wet” and “dry” ingredients. The so-called “dry” ingredients include the enriched wheat flour, baking soda, and salt. In the preferred embodiment, spices such as paprika and cayenne pepper powder are also added to the mixture. In addition, various preservatives may be added to maintain color and freshness of the batter ingredients. These preservatives include aluminum phosphate, monocalcium phosphate, and dextrose. The “wet” ingredients are then added to the dry ingredients so as to form a batter. The “wet” ingredients include water, milk, partially hydrogenated soybean and cottonseed oil, and eggs. The eggs act to add protein to the mixture and to stabilize the batter. The “wet” and “dry” ingredients are then mixed in a mixer to achieve a mixture having a viscosity of score of eight.

A viscosity score of eight means that the batter has a sticky thickness that will allow the batter to fall twelve inches from a device such as a spoon in eight tenths of a second. This consistency is appropriate to allow the mixture to adhere and surround the onions that are to be cooked.

Once the batter has been prepared, jalapeno pepper pieces, either fresh or processed, are added to the mixture. Typically, the jalapeno pepper pieces are about one percent of the mixture by volume. This amount can be adjusted depending upon the desires and demands of the customers that will purchase the product.

After the onion pieces are cleaned and sliced, they are visually inspected to ensure a desired size, shape, and quality. Once this has been done, the onions are coated in the batter. In the preferred embodiment, the onion pieces are moving along a belt conveyor as the various steps take place. In the embodiments the onions are coated by passing through a curtain of batter which drenches the onions. Once the onions are coated, they then make their way through a dipping process which ensures that the onion is completely covered with the batter mixture.

After the raw onions are coated with the batter, the dipped onions are passed along for further processing. The next step is to coat the batter dipped onion pieces with a breading. This is best done by sprinkling the breading mixture on to the dipped onion rings as they proceed along the conveyor belt, in a large-scale operation.

The breading mixture that is applied to these items consists of enriched wheat and barley flour, ferrous sulfate, high fructose corn syrup, partially hydrated soybean oil, buttermilk, whey, yeast, hydrolyzed corn protein, spices (calcium iodate, calcium dioxide), and calcium sulfate. These materials are combined, cooked to a crisp, and sprinkled on to the dipped, coated onions. Jalapeno pieces are also added to the breading mixture and are applied to the onion rings. The amount of jalapenos, as well as the characteristics of the breading mixture, may be altered depending upon the customer's specifications and demands.

Once the onion rings have been prepared, dipped, and breaded, they are cooked. In the preferred embodiment, the onion rings are only partially cooked and then frozen in a storage unit so as to allow these onion rings to be later prepared and cooked just prior to serving. The dipped and breaded onions are fried in oil that has been heated and kept at approximately 375 degrees Fahrenheit for approximately two and a half minutes. This process partially cooks the batter and in turn adheres the batter to the onion. After this has been done, the onions are removed from the heat and placed in a container wherein the onion rings can be quickly frozen and stored.

The containers having the frozen onion rings are then sold to a variety of outlets, which may sell the frozen product to consumers or which may sell to retail establishments that will cook and serve the onion rings to its customers.

When consumption of the onion rings is desired, the onion rings are removed from the frozen storage container and cooked in 375-degree oil for an additional two and a half minutes. As the products cool, a dash of salt may be added to the product to enhance flavor.

The exact amounts of ingredients that are used in the present invention vary according to the specific ingredients that are used and desired by the consumer. While the proportions of the ingredients in the mixture are only given as approximates, it is estimated that in order to produce 20,000 pounds of jalapeno onion rings, approximately 1750 pounds of batter and approximately 2500 pounds of breading would be required.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A coated food product having a coating comprised of a desired quantity of flour combined with a desired quantity of jalapeno pepper pieces; and a desired quantity of a liquid;
said quantities combined into a batter, said batter having a consistency sufficient to coat and adhere to said food item.

2. The coated food product of claim 1 wherein said food item is cooked for a period of time after said batter is applied to said food item so as to cook said batter around said food item.

3. The coating mixture of claim 1 further comprising a quantity of a binding agent said binding agent selected from the group consisting of eggs, shortening and oil.

4. The coating mixture of claim 1 further comprising a desired quantity of baking powder.

5. The coating mixture of claim 1 further comprising a desired quantity of salt.

6. The coating mixture of claim 1 wherein said liquid is selected from the group consisting of water, milk, carbonated water, lemon juice, and beer.

7. The coated food product of claim 1 wherein said quantity of flour is a mixture comprised of desired quantities of wheat flour, oil, baking soda, sodium aluminum phosphate, monocalcium phosphate, dextrose, and salt, and said liquid is a combination of water, milk and eggs, and wherein said batter has a consistency rating of between 6 and 10.

8. The coated food product of claim 7 wherein said food item is fried in oil having a temperature between 350 and 400 degrees Fahrenheit for between 2 and 6 minutes after said food item is coated with said batter.

9. The coated food product of claim 8 wherein a breaded coating is applied to said food item after said batter but prior to frying said item.

10. The coated food product of claim 9 wherein said breaded coating is comprised of a mixture having desired quantities of jalapeno peppers therein.

11. A coated onion ring having an outer coating comprising jalapeno pepper pieces, said onion ring made by the process of:
selecting an onion having a desired characteristics of shape, size and taste;
washing said onions to remove unwanted materials;
peeling said onion to remove unwanted layers of onion skin;
slicing said onion to produce onion slices having desired characteristics;
removing the center portions of said onion slices, so as to produce onion rings;
visually inspecting said onion rings;
coating said onion rings with a batter coating, said batter coating having jalapeno pepper pieces;
applying a breading on said batter coated onion rings, said breading having jalapeno pepper pieces; and
cooking said breaded, and coated onion ring.

12. The onion ring of claim 11 further comprising the steps of freezing said cooked onion ring, storing said cooked onion ring, and reheating said onion ring prior to consumption of said onion ring.

13. The onion ring of claim 11 wherein said batter is further comprised of desired quantities of flour, oil, baking soda, jalapeno pieces, salt, water, milk and eggs, and wherein said batter has a consistency rating of between 6 and 10.

14. The onion ring of claim 11 wherein said onion ring is fried in oil having a temperature between 350 and 400 degrees Fahrenheit for between 2 and 6 minutes after said food item is coated with said batter.
